(19) United States
(12) Patent Application Publication
(10) Pub. No.: US 2013/0225039 A1
(43) Pub. Date: Aug. 29, 2013

(54) Deer Rattling Device

(71) Applicant: Michael Castner, Dallas, PA (US)

(72) Inventor: Michael Castner, Dallas, PA (US)

(21) Appl. No.: 13/405,322

(22) Filed: Feb. 26, 2012

(51) Int. Cl. A01M 31/04

(52) U.S. Cl. 446/418

(57) ABSTRACT

An improved rattling device to replicate the sound of antlers of bucks engaged in combat. The device comprises a contoured base body assembly, a striker assembly, a flexible elastic connector that holds the striker assembly and contoured base together, a leg strap, and a belt hanger. The contoured base body contains a series of highly engineered variably sized hollow nodes. The striker assembly comprises a series of similarly sized hollow nodes. The nodes of the two-part contoured base body face the nodes of the striker assembly. In the rest position, the nodes are held firmly against each other by the force of the elastic connector.

### CROSS REFERENCE TO RELATED APPLICATIONS

None

### FEDERAL RESEARCH STATEMENT

None

### BACKGROUND OF THE INVENTION

This invention relates to an improved device to simulate the multiplicity of clashing antler sounds made by two bucks fighting. This sound is known as rattling and is indicative of two bucks engaging in combat. The sound of bucks in combat has been shown to attract other deer to the area. The instant device serves to attract deer to a hunter by simulating the sounds of bucks fighting.

### DESCRIPTION OF THE PRIOR ART

The prior art teaches several distinct types of devices used to simulate the sound of bucks engaging in combat—electronic devices, bag devices, and the use of real horns.

U.S. Pat. No. 6,757,574 issued to William J. Gardner et al on Jun. 29, 2004 reflects the state of the art with respect to simulating or reproducing animal sounds for the purpose of attracting them to hunters. The device disclosed in the '574 patent is essentially a device that plays pre-recorded sound clips of various animals in various situation. Included in these sounds is that of bucks fighting.

U.S. Pat. No. 6,234,865 issued to Michael L. Battey on May 22, 2001 teaches a device that comprises various antler parts inserted into a bag. The '865 patent represents the state of the art with respect to bag rattling devices. Actual or simulated antler parts are placed into a bag that contains strips of material. As the bag is shaken, the antler parts interact with the strips and produce a sound simulating combat between bucks.

U.S. Pat. No. 6,003,261 issued to Norman S. French on Dec. 21, 1999 teaches a device that discloses a mechanical method of simulating the sounds of bucks in combat comprising a plastic housing with nodes, a striker assembly and a method for moving the striker assembly against the nodes. The '261 patent represents the state of the art with respect to mechanical devices. There are two significant drawbacks to the French device. First, while the disclosure claims that the device can be operated with only one hand, in practice, it is virtually impossible to do so. The present device is specifically designed for easy one-handed operation. Second, the device does not produce the range of sounds at varying volumes that the instant device does.

Furthermore, U.S. Pat. D618,573 (Jun. 29, 2010) and D616,320 (May 25, 2010) both to Gregory S. Burcham represent variations on the mechanical rattling devices. However, they do not represent the same degree of sophistication and variability of sound produced by applicant's instant device. In fact, '573 and '320 are similar to designs developed by applicant and rejected as not producing the range of sounds required by a fully functioning rattling device.

While each of the above described devices are somewhat effective, they do have significant drawbacks. The electronic devices never quite reproduce the sound of bucks in combat while the rattling sound produced in the bag devices is somewhat muffled. In addition, the French device is cumbersome to use and does not feature the one handed operation that the applicant's instant device does. Finally, the '573 and '320 devices are monotonic in nature.

The instant device represents a significant improvement over the rattling device disclosed in U.S. Patent Application 20080318488 to the same applicant (Michael Castner) as the present invention.

None of the patents described above or the referenced prior art, taken either singly or in combination, are seen to disclose the specific combination of attributes disclosed by the present invention.

### SUMMARY OF THE INVENTION

The present invention is directed toward an improved device that can be simply and easily used to simulate the multiplicity and wide range of rattling sounds of the antlers of two bucks clashing against other during combat. It is a well known fact that the sound of antlers clashing attracts other deer to the area where the sound is being produced. As a hunter progresses through a forest or is perched in a deer stand, there is a requirement that he or she be able to simulate very closely the sound of buck antlers clashing in combat in order to attract deer to the area. There is a further requirement that the sound of clashing antlers be produced only when the hunter wants it to be produced and not at other inopportune times. The present invention meets all these requirements.

The present invention consists of a rattling device which comprises a two-part contoured base body which contains a series of raised hollow or partially hollowed nodes and a facing striker assembly which also contains a series of raised nodes. The raised nodes on the two-part contoured base body and the raised nodes on the striker assembly face each other. Owing to the fact that the device is contoured to the upper thigh of a typical hunter, the device can be easily and comfortably attached to the upper leg of a hunter with a leg strap and can further be attached to the hunter's belt by use of a belt hanger device. The nodes are of various sizes and shapes in order to produce antler-like sounds of varying frequencies and intensity. The contoured base body and striker assembly are joined together, by either a metallic elastic spring or a rubberized elastic connector such as high strength surgical tubing. One of the keys to the effectiveness of the device is that in the rest or unused position, the nodes of the striker assembly and the contoured base body are nestled together and held tightly in position by the elastic connector or surgical tubing or other similar means so that no noise is produced. When the hunter wants to simulate the sound of antlers engaged in combat, he or she moves the striker away from the rest position by pulling it slightly away from his or her body. He or she then rotates the striker slightly. The raised nodes of the striker rub against the raised nodes of the contoured base body and produce a sound that replicates the sound of buck antlers clashing. The hunter has the ability to produce the sound at varying volume levels and frequencies for varying amounts of time. The key to this device is that it allows for the production of a variety of clashing antler-like noises simultaneously. Virtually all other mechanical rattling devices produce only one sound at a time. This is important because a multitude of rattling sounds of varying frequencies and intensities are produced while bucks are engaged in combat. If only one type of sound is produced by a rattling device, it will not sound like bucks engaged in combat and deer will not be attracted.

The two-part contoured base body and striker assembly of the present invention can be made of any rigid material—i.e. metal, molded plastic, wood, etc. The nodes should be made of hard molded plastic or actual pieces of deer antlers. The elastic spring should be made of a lightweight, yet strong and flexible material such as surgical tubing. The leg strap is made of cloth texture and has an adjustable clasp. The belt hanger is plastic or metallic.

### BRIEF DESCRIPTION OF DRAWINGS

FIG. 1 shows a front view of the front half 20 of the two-part contoured base body of the rattling device. Major features shown include the raised nodes of varying sizes 30, the openings 40 through which sound can travel, and the slits 55 around the smaller nodes.

FIG. 2 is an overhead perspective view of the front half 20 of the two-part contoured base body of the rattling device. This view shows more clearly the raised nodes 30 and the openings 50. Also shown are the holes 60 through which the surgical tubing is inserted and the node 70 on the back of the front half of the two-part contoured base to which the surgical tubing attaches.

FIG. 3 is a side view of the front half 20 of the two-part contoured base body of the rattling device showing the relative size of the raised nodes 30.

FIG. 4 is a side view of the front half 20 of the two-part contoured base body.

FIG. 5 shows the front view of the striker assembly 100. Also shown are the various sized hollow nodes 110 of the striker and the holes 120 through which the surgical tubing is inserted.

FIG. 6 shows an exploded view of the device including the rear section 200 of the contoured base body, the front section 20 of the contoured base body and the striker assembly 100. The rear section 200 of the contoured base body is semi-permanently attached mechanically to the front section 20 thereby forming the entire contoured base body. The striker assembly 100 is flexibly connected to the contoured base body by surgical tubing or other similar elastic mechanical means.

FIG. 7 shows the fully assembled device 10 as it would be positioned on the body of a hunter and it further shows how a hunter can operate the device with just one hand while holding on to a bow or rifle with his or her other hand. In this particular view, the device is shown strapped around the leg of the hunter. In an alternate mode, the device can be suspended from a hunter's belt with a mechanical hanging device. This view also shows the striker resting snuggly against the contoured base body and being held in place by surgical tubing 260.

### DETAILED DESCRIPTION OF THE INVENTION

The present invention is directed toward an improved mechanical device that can be simply and easily used to simulate the multiplicity and wide range of rattling sounds produced by the antlers of two bucks clashing against other during territorial combat. The present invention consists of a rattling device which comprises a two-piece contoured base body which contains a series of highly engineered raised hollow or partially hollowed nodes and a highly engineered facing striker assembly which also contains a series of raised nodes. The rear piece of the contoured base body is contoured so that it fits the contour of a hunter's upper thigh.

The raised nodes on the contoured body and the raised nodes on the striker assembly face each other. The striker assembly is further designed such that it contours to the hand of the hunter. The device can be attached to the upper leg of a hunter with a leg strap and can further be attached to the hunter's belt by use of a belt hanger device.

The nodes on the contoured body and the striker are engineered to be of various sizes and shapes in order to produce antler-like sounds of varying frequencies and intensity. The contoured base body and striker assembly are joined together, by either a metallic elastic spring or a rubberized elastic device such as high strength surgical tubing. One of the keys to the effectiveness of the device is that in the rest or unused position, the nodes of the striker assembly and the contoured base body are nestled together and held tightly in position by the metallic spring or surgical tubing or other similar means so that no noise is produced. When the hunter wants to simulate the sound of antlers engaged in combat, he or she moves the striker away from the rest position by pulling it slightly away from his or her body. He or she then rotates the striker slightly. The raised nodes of the striker rub against the raised nodes of the contoured base body and produce a sound that replicates the sound of buck antlers clashing. The hunter has the ability to produce the sound at varying volume levels and frequencies for varying amounts of time.

A key to the effectiveness of this device is that it allows for the production of a variety of clashing antler-like noises simultaneously. Virtually all other mechanical rattling devices produce only one sound at a time. This is important because a multitude of rattling sounds of varying frequencies and intensities are produced while bucks are engaged in combat. If only one type of sound is produced by a rattling device, it will not sound like bucks engaged in combat and deer will not be attracted.

Another key to the effectiveness of this device is the engineering of the nodes, the holes and the sound board created by the rear segment of the contoured base body. The nodes are designed such that they produce a range of sounds highly analogous to those actually produced by the antlers of bucks engaging in combat. The highly engineered nodes are contoured and either hollow or partially hollow as are the antlers of real bucks. The sounds created by the nodes striking against each other and sliding off each other are amplified by bouncing off the sound board and are broadcast to the local environment through the holes and slits in the front segment of the contoured base body.

A further key to the effectiveness of the device is that it allows for true one handed utilization. Virtually all other rattling devices require the hunter use both hands to produce some semblance of rattling noises.

The applicant tested several configurations of the nodes and sound board against the actual recorded sound of bucks engaging in combat. The present configuration is virtually identical to the sound produced by battling bucks. Results of this test can be found on applicant's website. http://www.backmountainoutdoorproducts.com.

The major components of the instant device are a two piece contoured base body, a striker assembly, an elastic material that holds the striker snuggly against the contoured base body when it is not being used, and a means for attaching the device to either the upper thigh of a hunter or to the hunter's belt. The contoured base body is further comprised of a front segment that contains the various nodes, slits, and openings and a rear segment that contours to the upper thigh of a hunter and functions as a sound board for the sounds produced by the nodes of the striker and front segment engaging. The front and rear segments of the contoured base body are semi-permanently attached via mechanical means such that they form a sound chamber which serves to amplify the sounds produced by the engaging nodes.

The contoured base body and striker of the present invention can be made of any rigid material—i.e. metal, molded plastic, wood, etc. The nodes should be made of hard molded plastic or actual pieces of deer antlers. The elastic device that attaches the striker to the contoured base body should be made of a lightweight, yet strong and flexible material such as surgical tubing. The leg strap is made of cloth texture and has an adjustable clasp. The belt hanger is plastic or metallic.

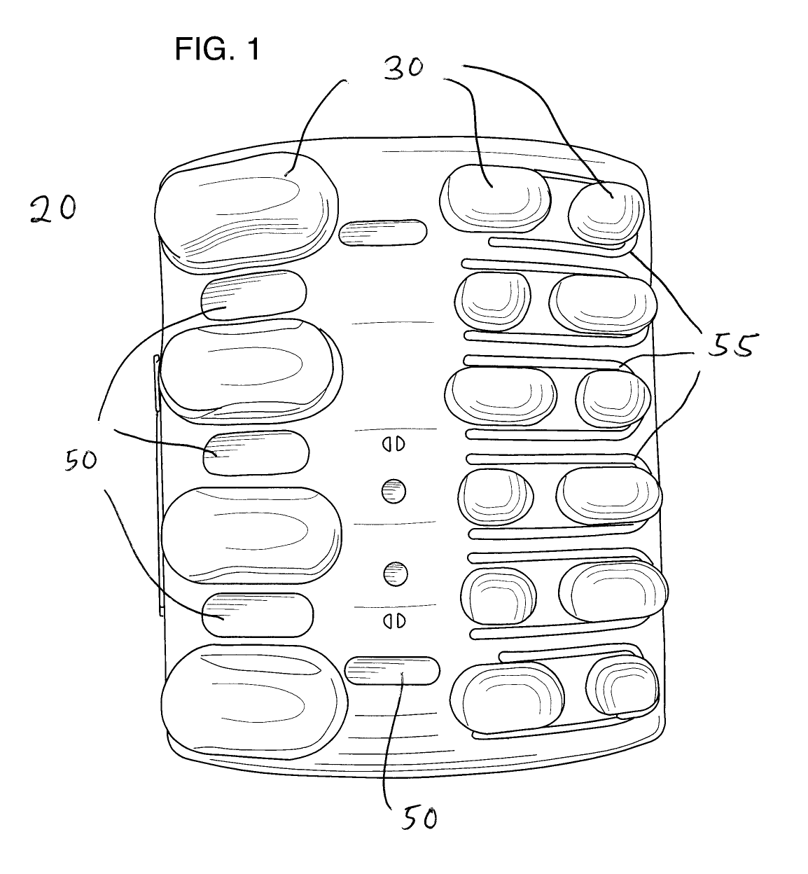

Referring to FIG. 1, a frontal view of the front segment 20 of the contoured base body is shown. The varying sized hollow nodes 30 are shown to be distributed throughout the front segment 20. The nodes are engineered and positioned such that they produce a variety and multitude of sounds when struck by the nodes of the striker assembly. Also shown are the various openings 50 and slits 55 that allow for sound to be broadcast from the sound chamber formed by the front and rear segments of the contoured base body.

The slits 55 represent another engineered feature of the device in that they allow for a small degree of axial movement of some of the smaller nodes thereby increasing the number of possible sounds and range of volumes produced by the engaging nodes.

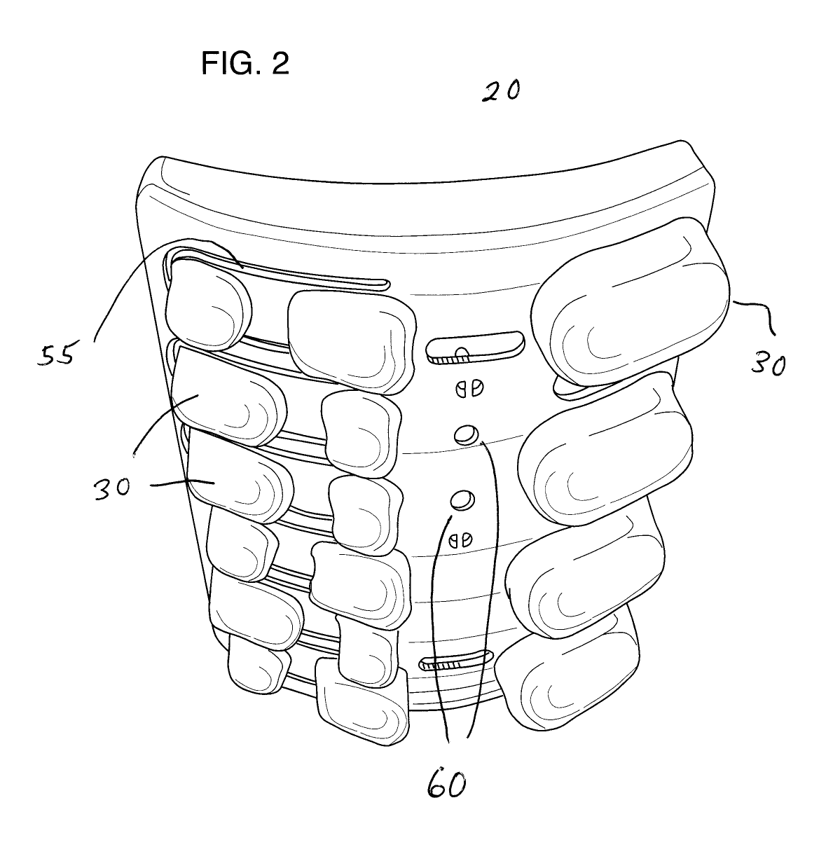

Referring to FIG. 2, a top perspective view of the front segment 20 is shown. This view shows that the nodes 50 are raised above the surface of the device and further shows the opening 50 and slits 55. Also shown are the holes 60 through which the elastic connector passes.

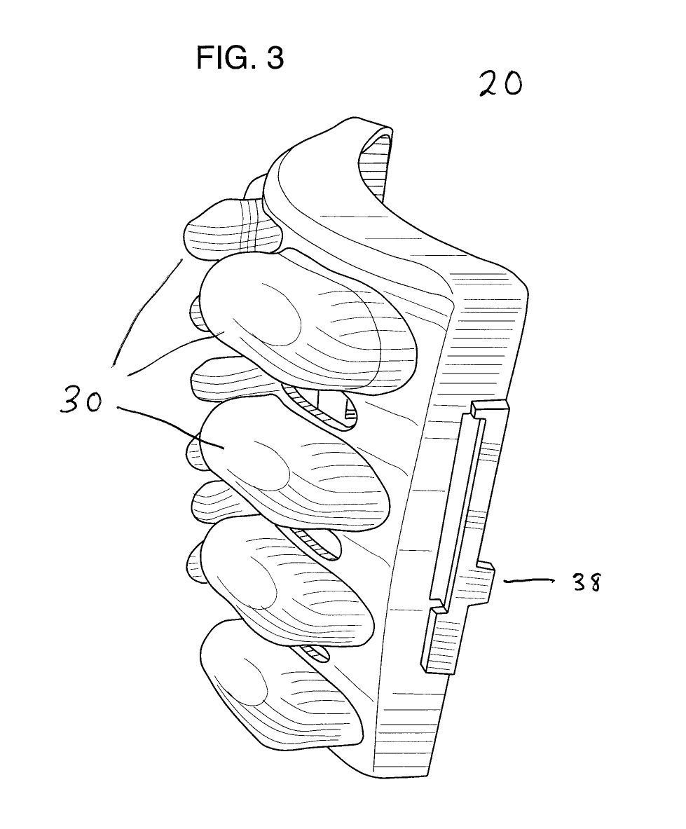

Referring to FIG. 3, a top perspective view of the front segment 20 is shown. This view shows the contour and depth of the front segment 20. The depth of the front segment is important because it allows a sound chamber to formed when the front and rear segments are attached. This view also shows the clear contouring and rounding of the various raised nodes. In addition, a representative mechanical latch 38 is shown which engages an appropriate fitting on the rear segment of the body holding it firmly and semi-permanently together.

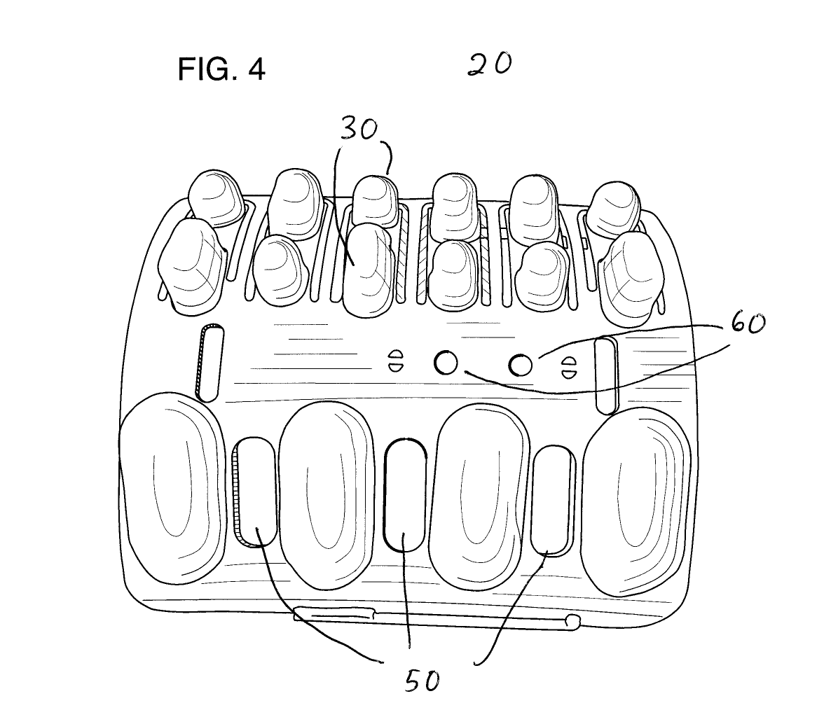

Referring to FIG. 4, a side perspective view of the front segment 20 is shown. This view shows the openings 50 and slits 55 as well as the holes 60 for the elastic connector.

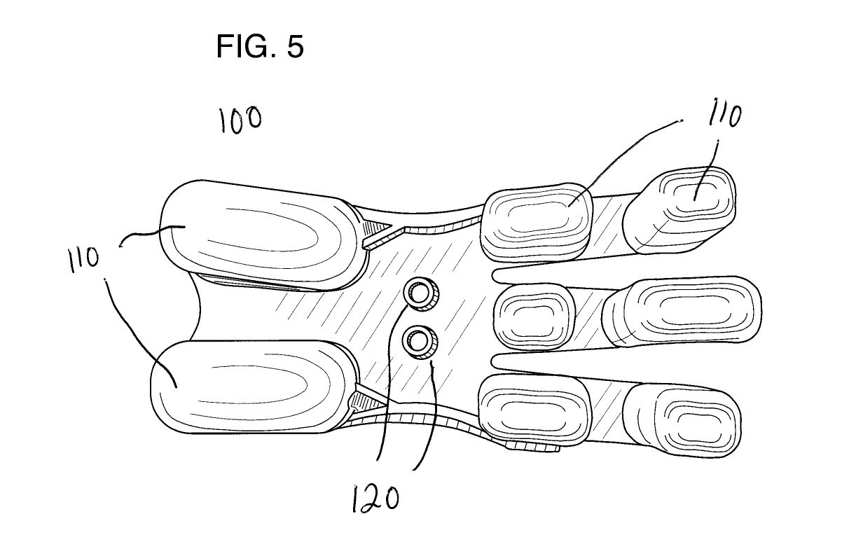

Referring to FIG. 5, a frontal view of the striker 100 is shown. The striker also has raised curved and contoured nodes 110 of varying sizes on the side facing the base. While these nodes are similar to those found on the front segment of the contoured base body, they have a slightly more oblong contour which allows for the variety and range of sounds created when the nodes of the striker engage the nodes of the base. Also shown are two holes 120 through which the elastic connector passes. The elastic connect passes through holes in both the striker and base and is affixed semi-permanently to the interior of the contoured base body. On the outer side, the striker assembly is contoured to accommodate the human hand and also comprises a series of finger grips designed to facilitate the ability of the hunter to grasp the striker assembly and slightly pull it away from the two part contoured base body and rotate the striker assembly to produce the rattling sound.

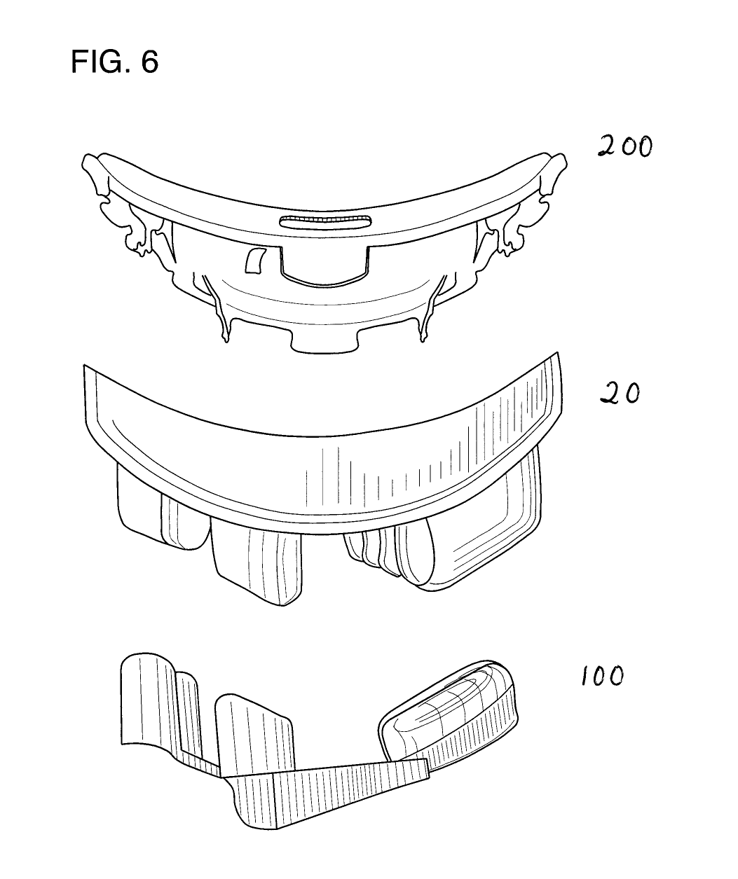

Referring to FIG. 6, an exploded view of the device is shown, including the rear segment of the contoured base body 200, the front segment of the contoured base body 20 and the striker 100. The rear and front segments of the contoured base are connected together to form the sound chamber which amplifies the sound of the clashing nodes. The two segments can be attached in any one of several mechanical means, including engaging plastic snaps, wire, clasps, etc. The striker is firmly and snuggly attached to the contoured base by means of elastic connectors such as surgical tubing.

In the rest position, the nodes of the striker 100 rest snuggly and are meshed in between the nodes of the base. The elastic connector holds the striker firmly against the outside of the base so that no sound is produced from the rest position. When the hunter wishes to create the sound of battling bucks, he or she merely grasps the outer side of the striker, which is contoured to comfortably conform to a hand, moves the striker slightly away from the base and rotates the hand slightly. The nodes of the striker strike the nodes of the base and create the rattling sound. The hunter can also move the striker up and down across the various nodes to create additional sounds.

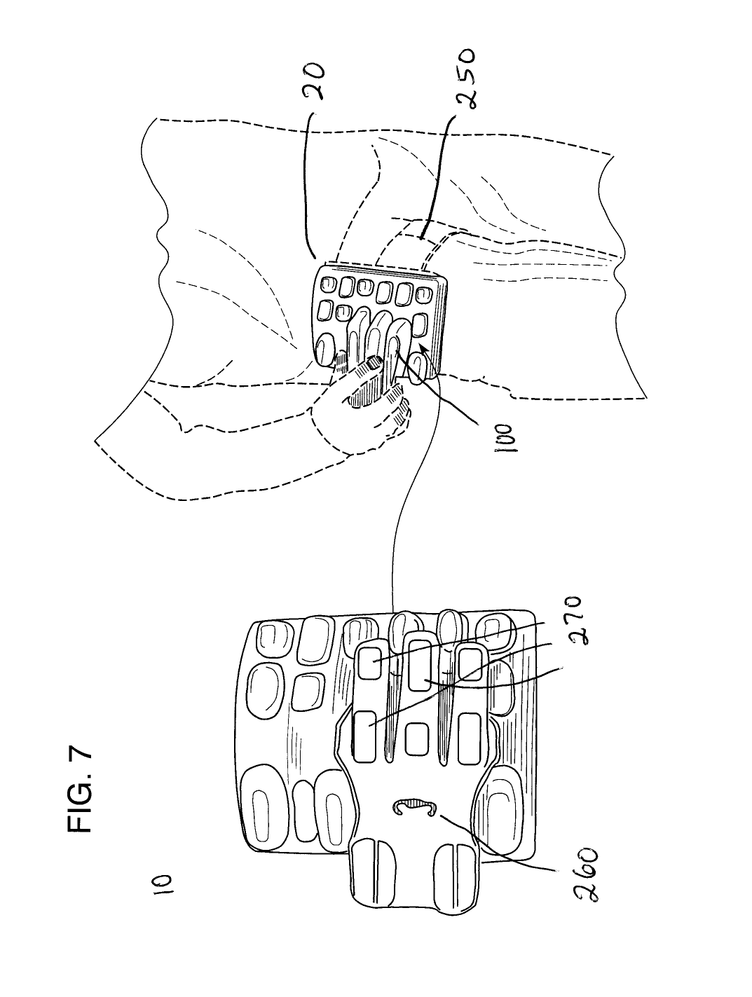

Referring to FIG. 7, an extracted and enlarged view of the device 10 is shown. Also shown is the relative position of the device on the hunter's upper thigh. This view shows that the device is attached to the hunter's leg via a thigh strap 250. In an alternate mode the device can be suspended from a hunter's belt using a belt clip. This view also shows the flexible elastic connector 260 emerging from and re-entering the holes in the striker assembly. Finally this view clearly shows the finger grips 270 on the striker assembly.

This view also presents the method in which the device is practiced. In general, the hunter grasps the outside of the striker, pulls it gently and slightly away from the base while the elastic connected provides resistance and then rotates the his or hand slightly to engage the various nodes of the base and the striker. The hunter can move the striker up and down as well as rotate it as is more clearly shown in applicant's website. www.backmountaintoutdoorproducts.com.

The device is generally between four and eight inches long, between three and seven inches wide, and between one half and two inches deep. The nodes are generally between one half and two inches in long diameter and are generally raised between one half inch and one and three quarters above the base. The openings are of varying sizes and are generally less than one inch along the major axis. The slits are generally less than one eighth inch wide.

The following is claimed:

1. An improved device to produce simultaneously the simulated sounds in a wide range of frequencies and volumes of animal antlers or horns clashing comprising:
a. a two-part contoured base body containing a series of hollow or semi-hollow nodes and a sound chamber,
b. a striker assembly containing a series of hollow or semi-hollow nodes,
c. an elastic connector holding the contoured two-part base body and the striker assembly together,
d. a leg strap that allows the improved device to be attached to a person's upper leg, and
e. a flexible and elastic connector that holds the two-part contoured base body together snuggly with the striker assembly.

2. A device as in claim 1 where the two-part contoured base body is contoured to fit the shape of a hunter's upper thigh.

3. A device as in claim 1 where the hollow and semi-hollow nodes of the two-part contoured base body and the striker assembly are of varying sizes to produce sounds of varying frequencies and intensities.

4. A device as in claim 1 where the hollow and semi-hollow nodes of the two-part contoured base body face outward and the hollow and semi-hollow nodes of the striker assembly face inward so that the nodes face each other.

5. A device as in claim 1 where the two-part contoured base body further comprises a front segment and a rear segment.

6. A device as in claim 1 where the outer portion of the striker assembly is contoured to accommodate the human hand and contains a series of finger grips.

7. A device as in claim 1 where the two-part contoured base body and the striker assembly are held snuggly together by a flexible connector.

8. A device as in claim 1 where the flexible elastic connector is surgical tubing.

9. A device as in claim 1 where the two-part contoured base body and the striker assembly are made of molded plastic.

10. A deer rattling device for producing the simulated sound of adult male animals with antlers engaged and clashing in combat, comprising:
a. a base having a series of hollow nodes; and
b. a striker having a series of nodes alignable and engageable with the series of nodes of the base for producing the simulated sound of adult male animals with antlers engaged in combat.

11. The deer rattling device of claim 10, further comprising a finger grip on the striker opposite of the striker nodes for gripping the striker and guiding the nodes of the striker into antler clashing sound making engagement with the hollow nodes of the base.

12. The deer rattling device of claim 10 wherein the nodes of the base and the striker directly oppose each other and fit snuggly together in the rest position as to not produce an inadvertent sound.

13. The deer rattling device of claim 10, further comprising an elastic spring loosely connecting the base and striker together.

14. The deer rattling device of claim 10 wherein the nodes of the base and the striker are of different shapes and directly oppose each other during use and nestle snuggly together during periods of non-use so as not to product inadvertent noise.

15. The deer rattling device of claim 10 where the device is actuated by slight movements of the hand and wrist.

16. A deer rattling device for producing the simulated sound of adult male animals with antlers engaged and clashing in combat, comprising:
a. a base having a series of hollow nodes;
b. a striker having a series of nodes alignable, engageable, and directly opposite with the series of nodes of the base during use and nestled snuggly and quietly together during periods of non-use; and
c. a finger grip on the striker opposite of the striker nodes for gripping the striker and guiding the nodes of the striker into antler clashing sound making engagement with the hollow nodes of the base for producing the simulated sound of adult male animals with antlers engaged in combat.

17. The deer rattling device of claim 16 wherein the base and the striker fit snuggly together in the rest position as to not produce an inadvertent sound.

18. The deer rattling device of claim 16, further comprising an elastic spring loosely connecting the base and striker together.

19. The deer rattling device of claim 16 wherein the nodes of the base and the striker are of different shapes.

20. The deer rattling device of claim 16 where the device is actuated by slight movements of the hand and wrist.

21. A deer rattling device for producing the simulated sound of adult male animals with antlers engaged and clashing in combat, comprising:
a. a base having a series of hollow nodes;
b. a striker having a series of nodes directly opposite, alignable and engageable with the series of nodes of the base wherein the base and the striker fit snuggly together in the rest position as to not produce an inadvertent sound and wherein the nodes of the base and the striker are of different shapes;
c. a finger grip on the striker opposite of the striker nodes for gripping the striker and guiding the nodes of the striker into antler clashing sound making engagement with the hollow nodes of the base for producing the simulated sound of adult male animals with antlers engaged in combat; and
d. an elastic spring loosely connecting the base and the striker together.

22. The deer rattling device of claim 21 where the device is actuated by slight movements of the hand and wrist.
